(19) United States
(12) Patent Application Publication
(10) Pub. No.: US 2010/0031201 A1
(43) Pub. Date: Feb. 4, 2010

(54) PROJECTION OF A USER INTERFACE OF A DEVICE

(75) Inventor: Ido de Haan, Assen (NL)

Correspondence Address: HARRITY & HARRITY, LLP, 11350 RANDOM HILLS ROAD, SUITE 600, FAIRFAX, VA, 22030, US

(73) Assignee: Sony Ericsson Mobile Communications AB, Lund (SE)

(21) Appl. No.: 12/183,373

(22) Filed: Jul. 31, 2008

(51) Int. Cl. G06F 3/033

(52) U.S. Cl. 715/863

(57) ABSTRACT

A method may include projecting, by a device, content on a surface, determining an orientation of the device, detecting a movement of the device, determining an operation that corresponds to the movement and interacts with the content, and performing the operation.

### BACKGROUND

With the development of consumer devices, such as mobile phones and personal digital assistants (PDAs), users are afforded an expansive platform to access and exchange information. In turn, our reliance on such devices has comparatively grown in both personal and business settings.

Unfortunately, certain design constraints exist with respect to these consumer devices. For example, the consumer device may be a portable device or a handheld device. The display may be relatively small in comparison to the size of, for example, a television or a monitor for a desktop computer. In such instances, the size of displaying content to the user is limited.

### SUMMARY

According to one aspect, a method may include projecting by a device, content on a surface, determining an orientation of the device, detecting a movement of the device, determining an operation that corresponds to the movement and interacts with the content, and performing the operation.

Additionally, the detecting may include determining whether the movement includes at least one of a gesture or a non-gesture, and where the determining the operation may include determining the operation that corresponds to the movement and interacts with the content when it is determined that the movement includes the gesture.

Additionally, the content may include a user interface of the device or other content accessible by the device.

Additionally, the operation may include any one of scrolling, selecting, entering data, highlighting, dragging-and-dropping, or navigating in a menu.

Additionally, the projecting may include, projecting, by the device, an indicator to navigate within the projected content.

Additionally, the method may include detecting at least one of acceleration or speed associated with the movement, and the performing the operation comprises performing the operation based on the at least one of detected acceleration or detected speed.

Additionally, the method may include communicatively coupling the device with another device, and where the content includes a user interface of the other device or other content accessible by the other device.

Additionally, the detecting may include detecting a user input in combination with the movement and determining the operation that corresponds to the user input in combination with the movement and interacts with the content.

Additionally, the method may include compensating for an instability of the content projected caused by the movement.

According to another aspect, a device may include a projector to project on a surface and one or more components that may be configured to detect a movement of the device, determine an operation that corresponds to the movement, where the operation interacts with the projected content, and perform the operation.

Additionally, the movement may be based on a user's gesture with the device.

Additionally, where, when detecting the movement of the device, the one or more components may be further configured to detect at least one of speed or acceleration associated with the movement.

Additionally, where the one or more components may be further configured to detect an orientation of the device, and the determining the operation that corresponds to the movement may be based on the orientation of the device.

Additionally, the device may correspond to a handheld device.

Additionally, the device may include a transceiver to communicatively couple with another device, and where the content may include a user interface of the other device or content accessible by the other device.

Additionally, the device may include an input device, and where the one or more components may be further configured to detect an input received from the input device and when determining the operation, the one or more components may be further configured to determine the operation based on the movement and the input received.

Additionally, the device may include a display.

Additionally, the content may include a software application running on the device.

According to still another aspect, a device may include means for projecting content on a surface, means for detecting a movement of the device, means for detecting an orientation of the device, means for determining an operation that interacts with the content based on the orientation and the detected movement, and means for performing the operation.

Additionally, where the operation may include navigating or moving an indicator within the projected content.

Additionally, the device may further include means for storing the content, and means for receiving content from another device or network.

### BRIEF DESCRIPTION OF THE DRAWINGS

The accompanying drawings, which are incorporated in and constitute a part of this specification, illustrate exemplary embodiments described herein and, together with the description, explain these exemplary embodiments. In the drawings:

FIG. 1 is a diagram illustrating concepts described herein;

FIG. 2 is a diagram illustrating a view of exemplary external components of an exemplary device that may be associated with the concepts described herein;

FIG. 3 is a diagram illustrating exemplary internal components that may correspond to the device depicted in FIG. 2;

FIGS. 4A and 4B are diagrams illustrating examples relating to a relationship between a user's gesture and an orientation of the device depicted in FIG. 2;

FIGS. 5A-5C are diagrams illustrating exemplary gestures that may be performed with the device depicted in FIG. 2;

FIG. 6 is a flow chart illustrating an exemplary process for performing operations that may be associated with the concepts described herein;

FIG. 7 is a diagram of an exemplary device that may be communicatively coupled with the device depicted in FIG. 2;

FIG. 8 is a diagram illustrating exemplary internal components that may correspond to the device depicted in FIG. 7;

FIG. 9 is a diagram illustrating an exemplary situation in which the device of FIG. 2 and the device of FIG. 7 may be utilized; and

FIG. 10 is a flow diagram illustrating another exemplary process for performing operations that may be associated with the concepts described herein.

### DETAILED DESCRIPTION

The following detailed description refers to the accompanying drawings. The same reference numbers in different drawings may identify the same or similar elements. Also, the following description does not limit the invention.

### Overview

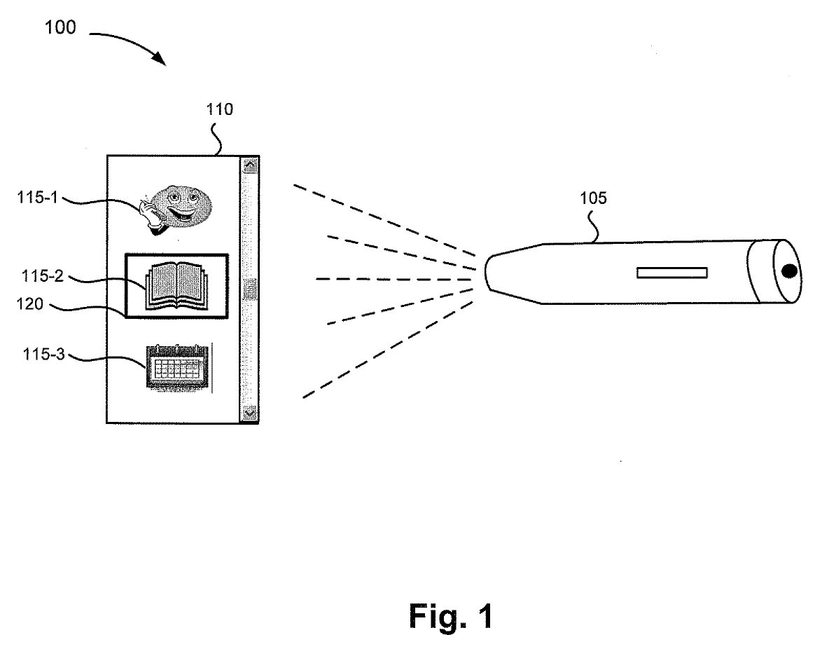

Given the physical constraints associated with portable or handheld devices, the displays on such devices may be relatively small. As an alternative and/or as an addition thereto, a device may project on a surface its user interface and/or other content (i.e., any content accessible by the device) to a user. In this way, the user is able to interact with the device without the hindrances associated with a small display. FIG. 1 is a diagram illustrating a concept 100 that provides a device with such capabilities.

As illustrated, a device 105 may project content to a user on a surface. For example, the content may correspond to a user interface 110 of device 105. User interface 110 may include, for example, icons 115-1, 115-2, and 115-3. The user may interact with device 105 via the projected user interface 110 based on the user's gesticulation. That is, the user may hold device 105 (e.g., in his or her hand) and make a gesture with the hand which causes device 105 to move in correspondence to the user's gesture. Device 105 may have the intelligence (e.g., logic) to discern the user's gesture and perform a corresponding operation. For example, the user may make a gesture to scroll. Device 105 may interpret the user's gesture to scroll and then scroll with respect to user interface 110. For example, a pointer or a selector (e.g., an indicator 120) or user interface 110 may scroll to icon 115-2 in response to the user's gesture. Additionally, device 105 may have the intelligence to discern the user's gesture from the user's non-gesture (e.g., the user's hand shaking when holding device 105). For example, device 105 may discern gestures from non-gestures based on certain thresholds. Further, device 105 may compensate for these types of movements (e.g., gestures or non-gestures) so that the content projected (e.g., user interface 110) may appear to the user as stabilized.

The user may also perform a selection or an enter operation based on the user's gesticulation. For example, as illustrated in FIG. 1, the user may discern that icon 115-2 is capable of being selected based on an indicator 120. The user may select icon 115-2 by performing another gesture. Device 105 may interpret the user's gesture to select or enter and select or enter icon 115-2. The user may then interact with an application or interface associated with the selection of icon 115-2.

The user may project user interface 110 in various orientations (e.g., in any plane of three-dimensional space), and device 105 may have the intelligence to discern the meaning of the user's gesture. Additionally, or alternatively, device 105 may be capable of being communicatively coupled to another device (not illustrated) to project content of that device (e.g., a user interface) and/or receive other types of content accessible by the other device. For example, the user may able to control the other device based on a projection of the user interface of that device. Additionally, or alternatively, the other device may be connected to a network (e.g., the Internet) or another device, and the user may use device 105 to project the network content (e.g., Web content). The user may interact with the network content in a manner similar to that previously described.

As a result of the foregoing, a user's operation of a consumer device may be less burdensome and provide an alternative way for the user to operate and/or interact with one or more devices. The concepts described herein have been broadly described in connection with FIG. 1. Accordingly, a detailed description and variations are provided below.

### Exemplary Device

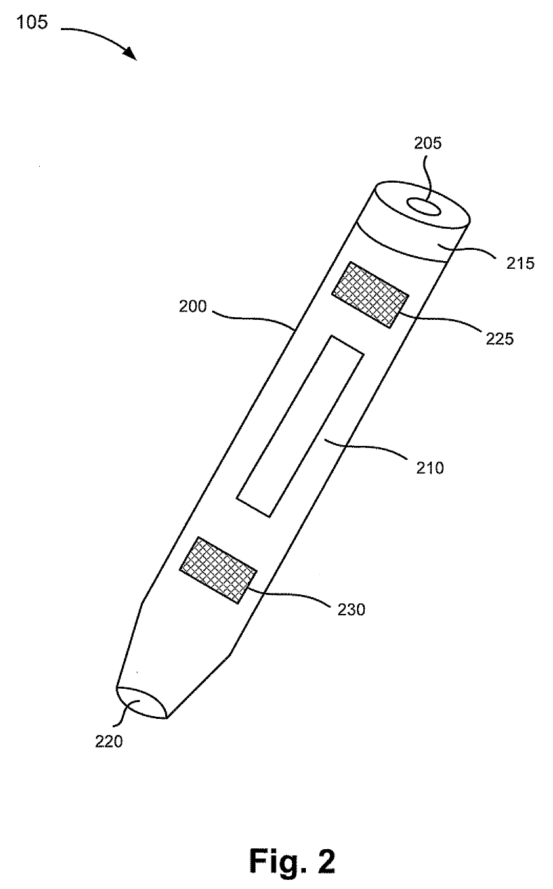

FIG. 2 is a diagram illustrating exemplary device 105. Device 105 is intended to be broadly interpreted to include any number of consumer devices. For example, device 105 may include a portable device or a handheld device, such as a wireless telephone, a PDA, an audio player, an audio/video player, an MP3 player, a gaming device, a pervasive computing device, a handheld computer, a data organizer, or another kind of communication, computational, and/or entertainment device. The term “component,” as used herein, is intended to be broadly interpreted to include, for example, hardware, a combination of hardware and software, and/or firmware.

As illustrated, device 105 may include a housing 200, a button 205, a display 210, a wheel 215, a projector lens 220, a speaker 225, and a microphone 230.

Housing 200 may include a structure capable of containing components and structures of device 105. For example, housing 200 may be formed from plastic and/or metal. Housing 200 may be formed of any shape and/or design. For purposes of description, device 105 is illustrated as having a pen-like shape.

Button 205 and wheel 215 may include a component capable of providing input to device 105. For example, button 205 may permit a user to make a selection (e.g., from information presented to a user on display 210), change a mode of device 105, turn on and turn off a function, and/or other types of input relating to the operation and use of device 105. Wheel 215 may permit a user to adjust a variable parameter (e.g., volume, parameters associated with projector 220), permit a user to scroll, etc.

Display 210 may include a component capable of providing visual information. For example, display 210 may include a liquid crystal display (LCD). In another implementation, display 210 may be any one of other display technologies, such as a plasma display panel (PDP), a field emission display (FED), a thin film transistor (TFT) display, etc. Display 210 may display, for example, text and/or graphical information to a user. It will be appreciated that device 105 may include display 210 even though device 105 includes projection capabilities, as well as other capabilities associated with the concepts described herein. Thus, in some instances, the concepts described herein may supplement a consumer device that includes a display. However, in other instances, the concepts described herein may replace the need for a display in a consumer device.

Projector lens 220 may include a structure capable of emitting an image from device 105. For example, projector lens 220 may include a projection lens system. The projection lens system may include a lens and other components used to project images.

Speaker 225 may include a component capable of transducing an electrical signal to a corresponding sound wave. For example, a user may listen to music through speaker 225.

Microphone 230 may include a component capable of transducing air pressure waves to a corresponding electrical signal. For example, a user may speak into microphone 230.

Although FIG. 2 illustrates exemplary external components and structures of device 105, in other implementations, device 105 may contain fewer, different, or additional external components and/or structures than the external components and structures depicted in FIG. 2. For example, device 105 may not include one or more of button 205, display 210, wheel 215, speaker 225, and/or microphone 230. Additionally, or alternatively, the external components and/or structures may be arranged differently than the external components and/or structures depicted in FIG. 2.

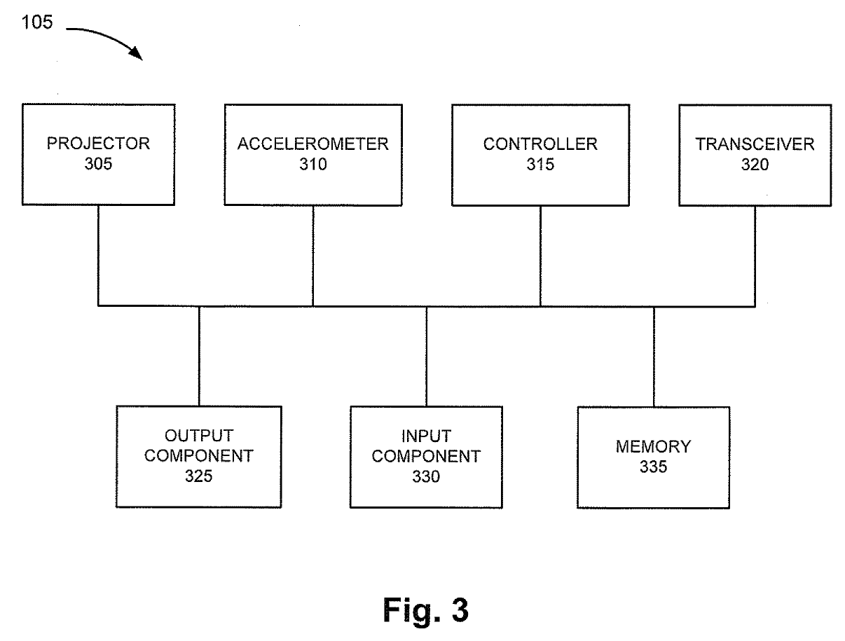

FIG. 3 is a diagram illustrating exemplary internal components of device 105. As illustrated, device 105 may include a projector 305, an accelerometer 310, a controller 315, a transceiver 320, an output component 325, an input component 330, and a memory 335.

Projector 305 may include a component capable of projecting images. For example, projector 305 may include a micro-electromechanical projection system (MEMS) (e.g., a digital micro-mirror device (DMD) component, digital light processing (DLP) component, or a grating light valve (GLV) component). In another implementation, projector 305 may include, for example, a liquid crystal display (LCD) projection system, a liquid crystal on silicon (LCOS) projection system, or some other type of projection system. Projector 305 may include a transmissive projector or a reflective projector.

Projector 305 may display content in one or more resolutions. For example, projector 305 may project content in high definition. Projector 305 may provide for various user settings, such as color, tint, resolution, etc. Projector 305 may also permit a user to identify other parameters that may affect the quality of the projected content. For example, the user may indicate the color of the surface, the type of surface (e.g., a user's hand, a screen, etc.) to which the content will be projected on, and/or a level of light in the environment (e.g., outside, inside, sunlight, etc.).

Accelerometer 310 may include a component capable of measuring acceleration forces. For example, accelerometer 310 may include a 3-axis accelerometer or a 2-axis accelerometer. Accelerometer 310 may include, for example, a capacitive accelerometer, a piezoresistive accelerometer, a piezoelectric accelerometer, a hall effect accelerometer, or a MEMS accelerometer. Accelerometer 310 may measure speed and/or trace or path information caused by the movement of device 105, as will be described in greater detail below. Movement of device 105 may include a gesture or a non-gesture (e.g., shaky hand of a user or other types of undesirable movement). Accelerometer 310 may include one or more gyroscopes for measuring and/or determining an orientation of device 105 and/or other types of gesture-based detectors (e.g., Logitech in-air gesture technology, etc.).

Controller 315 may include a component that interprets and executes instructions to control one or more other components of device 105. For example, controller 315 may include, a general-purpose processor, a microprocessor, a data processor, a co-processor, a network processor, an application specific integrated circuit (ASIC), a microcontroller, a programmable logic device, a chipset, and/or a field programmable gate array (FPGA).

Controller 315 may access instructions from memory 335, from other components of device 105, and/or from a source external to device 105 (e.g., a network or another device). Controller 315 may provide for different operational modes associated with device 105. Additionally, controller 315 may operate in multiple operational modes simultaneously. For example, controller 315 may operate in a camera mode, a music playing mode, a radio mode (e.g., amplitude modulation/frequency modulation (AM/FM)), and/or a telephone mode.

Controller 315 may receive movement information from accelerator 310. Movement information may include gesture information and/or non-gesture information. Controller 315 may distinguish and/or determine whether a movement corresponds to a gesture or a non-gesture. For example, controller 315 may distinguish between a gesture or a non-gesture based on threshold values. These threshold values may relate to various parameters associated with a movement. For example, these parameters may include length of movement, speed of movement, acceleration of movement, direction, the number of direction changes associated with a movement, the duration of a movement, etc. Controller 315 may determine compensation information based on the movement information so that content projected by projector 305 remains relatively stable. For example, controller 315 may receive gesture information from accelerometer 310. Gesture information may include, for example, trace or path information, an acceleration measurement, a speed measurement, and other types of information related to a user's gesture with device 105. Controller 315 may utilize the gesture information so that the user's gesture is able to be interpreted to interact with a projected content. Controller 315 may include intelligence (e.g., logic) to interpret an orientation of device 105 so that a user's gesture may be accurately interpreted. Additionally, controller 315 may determine compensation information based on the gesture information so that the projected content may be stabilized on a surface. Projector 305 may project an image based on the compensation information.

Controller 315 may receive non-gesture information from accelerometer 310. Non-gesture information may include, for example, trace or path information, an acceleration measurement, a speed measurement, and other types of information related to a user's gesture with device 105. Controller 315 may determine compensation information based on the non-gesture information so that the projected content may be stabilized on a surface. Projector 305 may project an image based on the compensation information.

Transceiver 320 may include a component capable of transmitting and receiving data. For example, transceiver 320 may include a component that provides for wireless and/or wired communication with a network or another device.

Output component 325 may include a component capable of outputting information from device 105. For example, as previously described, device 105 may include a display 210 and a speaker 225. Device 105 may include other components, not specifically described herein, that may provide output to a user. For example, output component 325 may include a vibration component, and/or some other type of auditory, visual, and/or tactile output.

Input component 330 may include a component capable of inputting information to device 105. For example, as previously described, device 105 may include button 205, wheel 215, and microphone 230. Device 105 may include other components, not specifically described herein, that may receive input from a user. For example, input component 330 may include a voice recognition component, and/or some other type of input component.

Memory 335 may include a component capable of storing data and/or instructions related to the operation and use of device 105. For example, memory 335 may include a random access memory (RAM), a dynamic random access memory (DRAM), a static random access memory (SRAM), a synchronous dynamic random access memory (SRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory. Memory 335 may also include an external component, such as a universal serial bus (USB) memory stick, a memory card, and/or a subscriber identity module (SIM) card.

Memory 335 may include applications. For example, applications may include a variety of software programs, such as a contact list, a digital audio player, a digital media player, an organizer, a text messenger, a calendar, a game, a web browsing device, a projector, a camera, etc.

Although FIG. 3 illustrates exemplary components of device 105, in other implementations, device 105 may include different, additional, and/or fewer components than those depicted in FIG. 3. For example, device 105 may include a component (e.g., a sensor) to determine a distance from device 105 and a surface in which the content is to be projected. Device 105 may utilize this distance information to compensate for movement of device 105 based on, for example, trigonometric relationships that exist between the movement of device 105 and the content projected on a surface. Additionally, or alternatively, a component described as performing a particular operation may be performed by one or more other components, in combination with the component and one or more other components, or another component (e.g., a dedicated component) not specifically described herein.

As previously described, device 105 may project content (e.g., a user interface of device 105 or some other content accessible by device 105) on a surface. A user may interact with the projected content based on a user's gesticulations with device 105. For example, a user may move device 105 to perform operations that interact with the projected content. A movement of device 105 may correspond to a trace or a path. Additionally, the movement may have a corresponding acceleration and speed. For example, a user may move device 105 having a particular acceleration and/or speed. Thus, device 105 may detect a trace or a trace and a speed and/or acceleration associated with the movement of device 105 caused by the user's gesture.

A user may move device 105 to perform operations that interact with the projected content. These operations may include, for example, scrolling, selecting, highlighting, dragging-and-dropping, navigating in a menu (e.g., a pull-down menu, a popup menu, etc.), entering data, etc. Accordingly, a user may interact with the projected content and have available various operations corresponding to those provided by a mouse, a keyboard, or other types of input devices (e.g., a joystick, etc.).

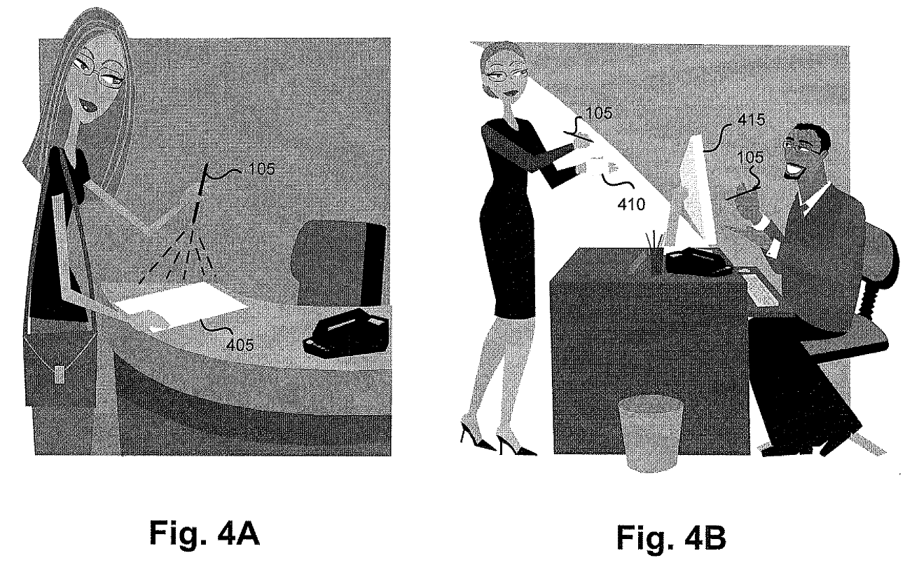

It will be appreciated that depending on the orientation of the projected content, the user may move device 105 differently (e.g., a different trace) in space (e.g., in three-dimensional space). For example, as illustrated in FIG. 4A, if the user projects content on a surface that is substantially normal to the user (e.g., on a surface of a desk), projected content 405 may be on a plane substantially normal to the user. In such an instance, the user's movement of device 105 for causing a particular operation to be performed may be different than the corresponding operation if the user causes device 105 to project content on a surface that is substantially parallel to the user. For example, as illustrated in FIG. 4B, projected content 410 and 415 may be on a plane that is substantially parallel to the user. Thus, for example, assuming the user may perform an accept or an enter gesture by moving device 105 in a line normal to projected contents 405, 410, and 415, such movement of device 105 may be different within three-dimensional space based on the orientation of device 105 and projected contents 405, 410, and 415. In this regard, device 105 may include intelligence to determine the orientation of device 105 and/or the projected content. For example, controller 315 and/or some other component may determine the orientation of device 105 and/or the orientation of the projected content. In one implementation, device 105 may include a default orientation (e.g., a reference orientation) so that an orientation other than the default orientation may be determined. Additionally, or alternatively, a user may set (e.g., program) an orientation as a reference orientation. For example, the user may press button 205 to cause device 105 to establish a particular orientation as the reference orientation. In either case, a movement of device 105 based on a user's gesticulation may be correctly interpreted by device 105 and an operation corresponding to the movement of device 105 may be performed.

It will be appreciated that a user may project content on variety of surfaces. For example, as illustrated in FIG. 4B, the user may project content (e.g., projected content 410) on a body part (e.g., a hand). Thus, the user may operate device 105 virtually anywhere or anytime. Further, although not illustrated in FIGS. 4A and 4B, the projected content may include an indicator or reference (e.g., indicator 120, as illustrated in FIG. 1) to allow the user to navigate and/or interact with the projected content.

Additionally, or alternatively, device 105 may recognize a set of default movements or gestures (e.g., a stroke from left to right, a stroke from right to left, a tap movement) that may be performed by a user for a particular operation (e.g., to scroll from left to right, to scroll from right to left, to enter a character or to make a selection). Additionally, or alternatively, device 105 may provide that a user may set (e.g., program) a movement to correspond to a particular operation. In such an instance, when a relationship between gesture (e.g., a stroke from left to right) and operation (e.g., scroll from left to right) is established, device 105 may perform the corresponding operation (e.g., scrolling, selecting, etc.). In instances where device 105 is in an orientation other than the orientation from which the relationship was established (e.g. programmed by the user, default of device 105, etc.), device 105 may still recognize the relationship between gesture and operation by a translation of a determined orientation. For example, it may be assumed that a user may perform the same gesture and desire the same operation regardless of the orientation of the projected content.

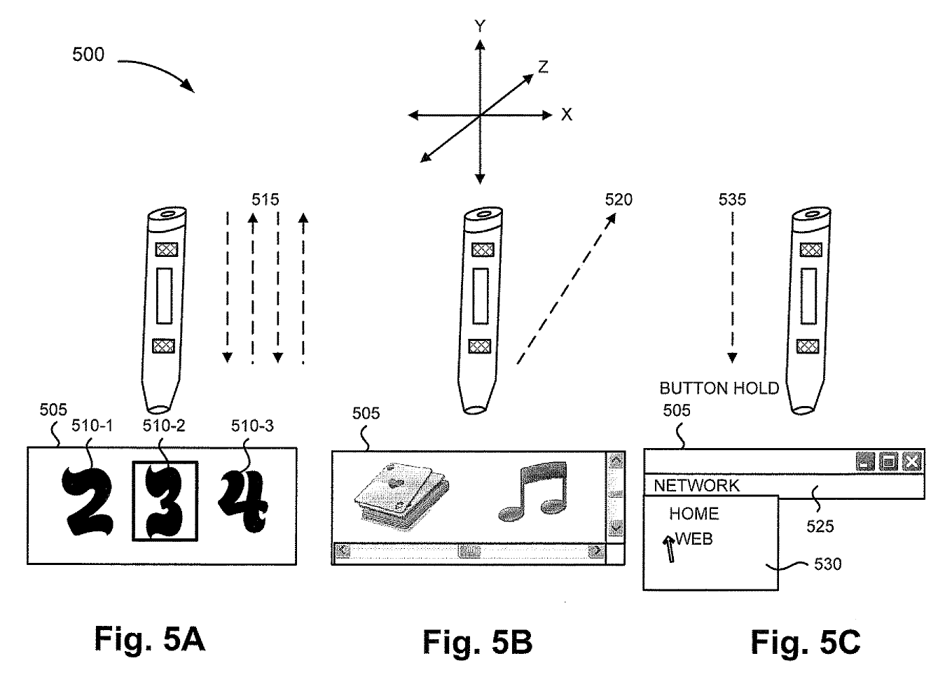

Given the variety of orientations with which a user may utilize device 105 and the corresponding orientations of the projected content, a user may move device 105 in many ways. For example, a user may move device 105 in any manner in three-dimensional space. FIGS. 5A through 5C illustrate some exemplary operations that may be performed with device 105, in addition to those previously mentioned, and those not specifically described. It will be appreciated that the gestures depicted in FIG. 5A through FIG. 5C are exemplary.

FIG. 5A is a diagram illustrating an exemplary operation. As illustrated, device 105 may project content 505 that includes numerals 510-1, 510-2 and 510-3. In other instances, content 505 may include, for example, a keyboard of alphabetic characters, and/or some other type of symbol(s), icon, object, etc. Assume that a user wishes to enter numeral 510-2 into device 105. The user may perform a double tap gesture 515 (represented by arrows in FIG. 5A) with device 105 to cause numeral 510-2 to be entered. That is, as illustrated by double tap gesture 515, a user may move device 105 in an up-down motion twice to simulate a double tap. Of course, the user may move device 105 in this manner in mid-air without having to physically contact the projected content 505.

FIG. 5B is a diagram illustrating another exemplary operation. As previously described, a user may scroll. For example, a user may scroll left to right, right to left, up to down, down to up, etc. However, a user may perform a more complex scroll. For example, assume that a user wishes to reach an icon that is in an upper right corner of projected content 505. A user may perform an angled gesture 520 (represented by an arrow in FIG. 5B) with device 105 to cause a scrolling of left to right and a scrolling from down to up. Additionally, accelerometer 310 may be used to detect speed and/or acceleration for causing fast scrolling as opposed to slow scrolling depending on the movement (i.e., the user's gesture).

FIG. 5C is a diagram illustrating another exemplary operation. As illustrated, projected content 505 may include a menu bar 525 and a drop down menu 530. Assume that a user wishes to navigate to drop down menu 530 to select “Web” (e.g., to connect to the Web). In such an instance, a user may select “Network” from menu bar 525, and drop down menu 530 may appear. User may select “Web” by a tap “Web” by a tap gesture 535 while holding down button 205. In this regard, a user's movement of device 105 may be combined with, for example, a button push, or other types of input (e.g., a voice input). For example, a user may touch a particular area of device 105 (e.g., a touch pad (not illustrated) or a pre-configured button or input device) to achieve a particular combinatorial gesture.

It will be appreciated that FIGS. 5A through 5C are not intended as an exhaustive description of the possible operations that a user may perform based on a user's gesture with device 105. However, as previously described, a user may interact with projected content and have available various operations that correspond to those provided by a mouse, a keyboard, or other types of input devices (e.g., a joystick, etc.), as well as other operations that may not be possible by such conventional input devices.

### Exemplary Process

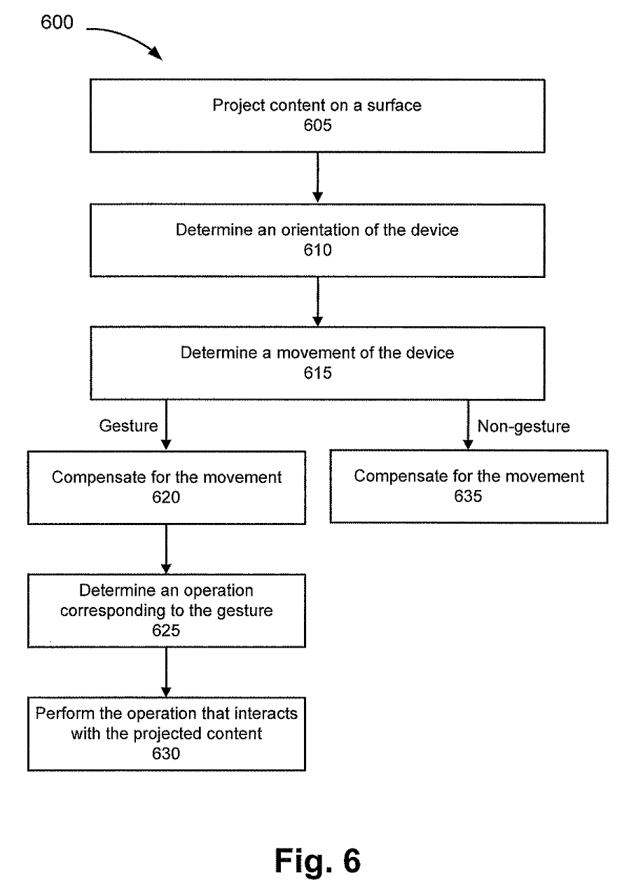

FIG. 6 is a flow diagram illustrating an exemplary process 600 associated with device 105 for interacting with projected content.

Process 600 may begin with content being projected on a surface (block 605). Device 105 may project content on a surface. For example, projector 305 of device 105 may project content on a user's body part (e.g., a user's hand), a wall, a screen, or any other type of surface. The content may include, for example, a user interface of device 105 and/or other forms of content accessible to device 105 (e.g., network content). Device 105 may enable a user to adjust various parameters (e.g., color, tint, resolution, etc.) associated with the projected content. The projected content may include an indicator 120 to provide a reference to a user and/or device 105 with respect to a subsequent movement or user gesture.

An orientation of the device may be determined (block 610). Device 105 may determine an orientation. For example, controller 315 of device 105 may determine the orientation of device 105 based on a reference orientation. For example, the reference may be pre-configured and/or set by a user.

A movement of the device may be determined (block 615). Device 105 may determine a movement. For example, accelerometer 310 of device 105 may detect a user's gesture with device 105. A gesture may include a trace or path. For example, a user may move device 105 in a relatively straight line from right to left, left to right, up to down, down to up, in a diagonal manner, in a curved manner, freehand, etc. In other instances, a gesture may include a more complex trace or path. For example, a user may make a double tap gesture with device 105. Still, in other instances, a gesture may include a movement with device 105 in combination with, for example, an additional input mechanism of device 105. For example, the additional device 105 input may include pressing a button (e.g., button 205), etc. A gesture may include, in addition to a trace or a path, other aspects of the movement of device 105, such as acceleration, speed, etc., which may be detected. Similarly, accelerometer 310 of device 105 may detect a user's non-gesture with device 105. For example, a non-gesture may include a user's hand shaking or some other undesirable movement. A non-gesture may include movement information (e.g., trace, speed, acceleration, etc.).

Controller 315 may determine whether the movement corresponds to a gesture or a non-gesture. As previously described, a gesture may correspond to a movement of device 105 in which, for example, an operation corresponding to the gesture is to be performed. On the other hand, a non-gesture may correspond to an undesirable movement (e.g. a user's hand shaking, etc.) of device 105. Controller 315 may determine whether the movement corresponds to a gesture or a non-gesture based on the characteristics of the movement. In one implementation, controller 315 may utilize thresholds associated with a movement to distinguish between a gesture and a non-gesture. For example, a trace or path length associated with a non-gesture may be relatively short in comparison to a trace or path length associated with a gesture. That is, given the nature or movement characteristics (e.g., trace, speed, acceleration, etc.) of a non-gesture and a non-gesture, thresholds may be established to allow controller 315 to distinguish between a gesture and a non-gesture.

If it is determined that the movement is a gesture (block 615-Gesture), then the movement may be compensated (block 620). For example, device 105 may stabilize the content projected on the surface based on compensation information. For example, controller 315 may determine compensation information based on movement information, distance information, etc. Projector 305 may utilize the compensation information to stabilize the content projected on a surface.

An operation corresponding to the gesture may be determined (block 625). Device 105 may determine an operation corresponding to the gesture. For example, controller 315 of device 105 may determine an operation (i.e., an operation that interacts with the projected content) based on the gesture. An operation may include, for example, an interaction with the projected content that is analogous to or equivalent to that which may be performed by other conventional devices (e.g., a mouse, a keyboard, a wheel, a joystick, etc.), as well as other operations that may not be possible by such conventional input devices. The operation may also include aspect related to acceleration, speed, etc. For example, an operation such as scrolling may have varying degrees of scrolling (e.g., the speed of the scroll, the length of the scroll, etc.) based on acceleration, speed, etc., associated with the user's gesture.

The operation that interacts with the projected content may be performed (block 630). For example, device 105 may perform various operations corresponding to the gesture. As previously described, these operations may include selecting, entering data, scrolling, dragging- and dropping, navigating in a menu (e.g., a pull-down menu, a popup menu, etc.), highlighting, etc.

If it is determined that the movement is a non-gesture (block 615-Non-gesture), then the movement may be compensated (block 635). For example, device 105 may stabilize the content projected on the surface based on compensation information. For example, controller 315 may determine compensation information based on movement information, distance information, etc. Projector 305 may utilize the compensation information to stabilize the content projected on a surface.

Although FIG. 6 illustrates an exemplary process 600, in other implementations, process 600 may include fewer, different, and/or additional operations than those described. For example, depending on the distance between device 105 and a surface in which the content is projected, and the characteristics of the movement, compensation of the movement may not be necessary. It will also be appreciated that components of device 105 described as performing a particular operation, may be performed by other components of device 105, in combination with other components of device 105, and/or components not specifically mentioned herein.

### Exemplary Device Communicatively Coupled with Another Device

As previously described, device 105 may project content (e.g., a user interface of device 105) on a surface that would permit a user to interact with the projected content. In other instances, however, device 105 may be communicatively coupled to another device. For example, the other device may include a portable device, a handheld device, or a stationary device. For example, the other device may be a wireless telephone, a PDA, a web browsing device, a desktop computer, a laptop computer, a fax machine, stereo equipment, a digital video disc (DVD) player, a compact disc (CD) player, home office equipment, a device in an automobile, a game system, a data organizer, etc.

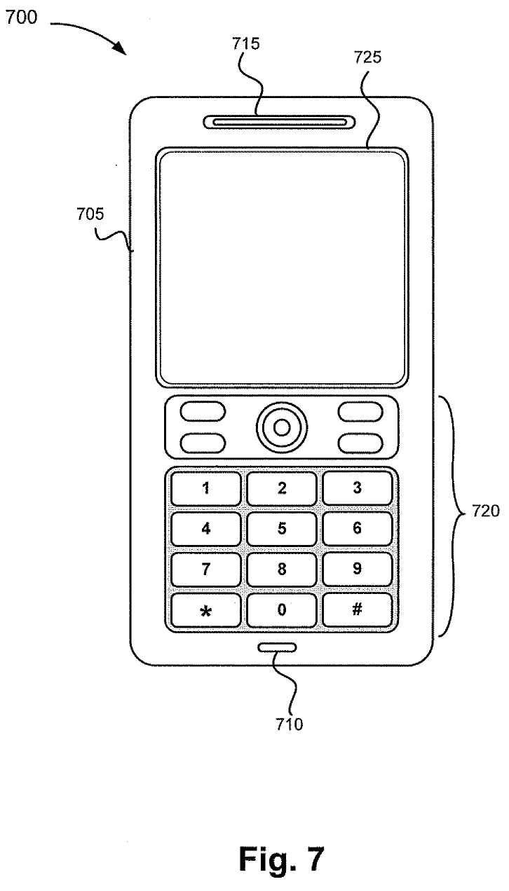

FIG. 7 is a diagram illustrating an exemplary device 700 that may be communicatively coupled to device 105. Device 700 may include a housing 705, a microphone 710, a speaker 715, a keypad 720, and a display 725.

Housing 705 may include a structure to contain components of device 700. For example, housing 705 may be formed from plastic or metal and may support microphone 710, speaker 715, keypad 720, and display 725.

Microphone 710 may include a component capable of transducing air pressure waves to a corresponding electrical signal. For example, a user may speak into microphone 710 during a telephone call. Speaker 715 may include a component capable of transducing an electrical signal to a corresponding sound wave. For example, a user may listen to music or listen to a calling party through speaker 715.

Keypad 720 may include a component capable of providing input to device 700. Keypad 720 may include a standard telephone keypad. Keypad 720 may also include one or more special purpose keys. In one implementation, each key of keypad 720 may include, for example, a pushbutton. A user may utilize keypad 720 for entering information, such as text, a phone number, or activating a special function.

Display 725 may include a component capable of providing visual information. For example, in one implementation, display 725 may include a liquid crystal display (LCD). In another implementation, display 725 may include any one of other display technologies, such as a plasma display panel (PDP), a field emission display (FED), a thin film transistor (TFT) display, etc. Display 725 may display, for example, text, image, and/or video information to a user.

Although FIG. 7 illustrates exemplary external components of device 700, in other implementations, device 700 may contain fewer, different, or additional external components than the external components depicted in FIG. 7. Additionally, or alternatively, one or more external components of device 700 may perform the functions of one or more other external components of device 700. For example, display 725 may include an input component (e.g., a touch screen). Additionally, or alternatively, the external components may be arranged differently than the external components depicted in FIG. 7.

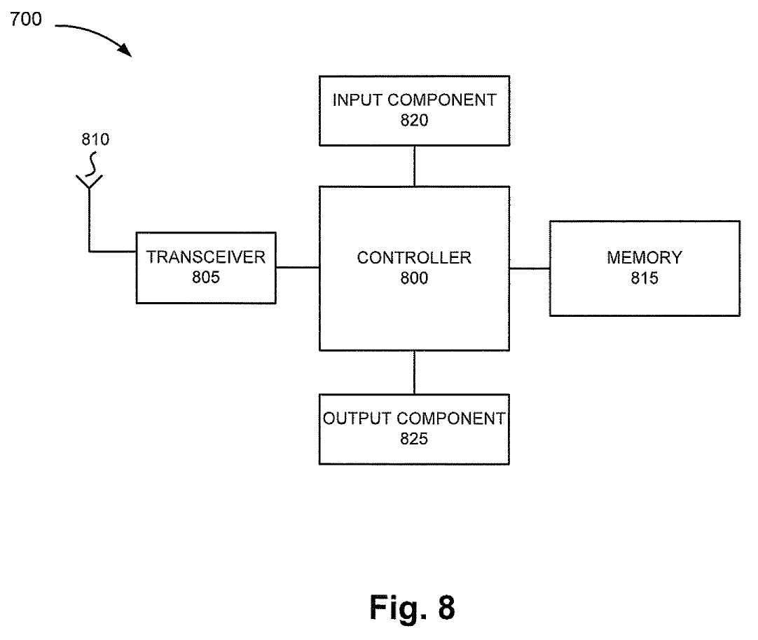

FIG. 8 is a diagram illustrating exemplary internal components of device 700 depicted in FIG. 7. As illustrated, device 700 may include a controller 800, a transceiver 805, an antenna 810, a memory 815, an input component 820, and an output component 825.

Controller 800 may include a component that interprets and executes instructions to control one or more other components of device 700. For example, controller 800 may include, a general-purpose processor, a microprocessor, a data processor, a co-processor, a network processor, an application specific integrated circuit (ASIC), a microcontroller, a programmable logic device, a chipset, and/or a field programmable gate array (FPGA).

Controller 800 may access instructions from memory 815, from other components of device 700, and/or from a source external to device 700 (e.g., a network or another device). Controller 800 may provide for different operational modes associated with device 700. Additionally, controller 800 may operate in multiple operational modes simultaneously. For example, controller 800 may operate in a camera mode, a music playing mode, a radio mode (e.g., amplitude modulation/frequency modulation (AM/FM)), and/or a telephone mode.

Transceiver 805 may include a component capable of transmitting and receiving data. For example, transceiver 805 may include a component that provides for wireless communication with a network or another device via antenna 810 and/or wired communication with a network or another device via, for example a port (not illustrated). Transceiver 805 may include a transmitter and a receiver. Transceiver 805 may be capable of performing various communication-related operations (e.g., filtering, de/coding, de/modulation, etc.). Antenna 810 may include a component capable of receiving information and transmitting information via a wireless channel.

Memory 815 may include a component capable of storing data and/or instructions related to the operation and use of device 700. For example, memory 815 may include a random access memory (RAM), a dynamic random access memory (DRAM), a static random access memory (SRAM), a synchronous dynamic random access memory (SRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory. Memory 815 may also include an external component, such as a universal serial bus (USB) memory stick, a memory card, and/or a subscriber identity module (SIM) card.

Memory 815 may include applications. For example, applications may include a variety of software programs, such as a contact list, a digital audio player, a digital media player, an organizer, a text messenger, a calendar, a game, a web browsing device, a camera, etc.

Input component 820 may include a component capable of inputting information to device 700. For example, input component 820 may include a keyboard, a keypad, a mouse, a button, a joystick, a touchpad, a switch, a microphone, a display, voice recognition logic, and/or some other component capable of an auditory and/or tactile input.

Output component 825 may include a component capable of outputting information from device 700. For example, output component 825 may include a display, a speaker, one or more light emitting diodes (LEDs), a vibrator, and/or some other component capable of an auditory, visual, and/or tactile output.

Although FIG. 8 illustrates exemplary internal components, in other implementations, fewer, additional, and/or different internal components than the internal components depicted in FIG. 8 may be employed. For example, one or more internal components of device 700 may include the capabilities of one or more other components of device 700. For example, controller 800 and/or transceiver 805 may include their own on-board memory 815.

Device 105 may operate in conjunction with another device, such as device 700. Device 105 may project content received from (or via) device 700. The content may include, for example, a user interface of device 700 or some other content accessible by device 700 (e.g., network content).

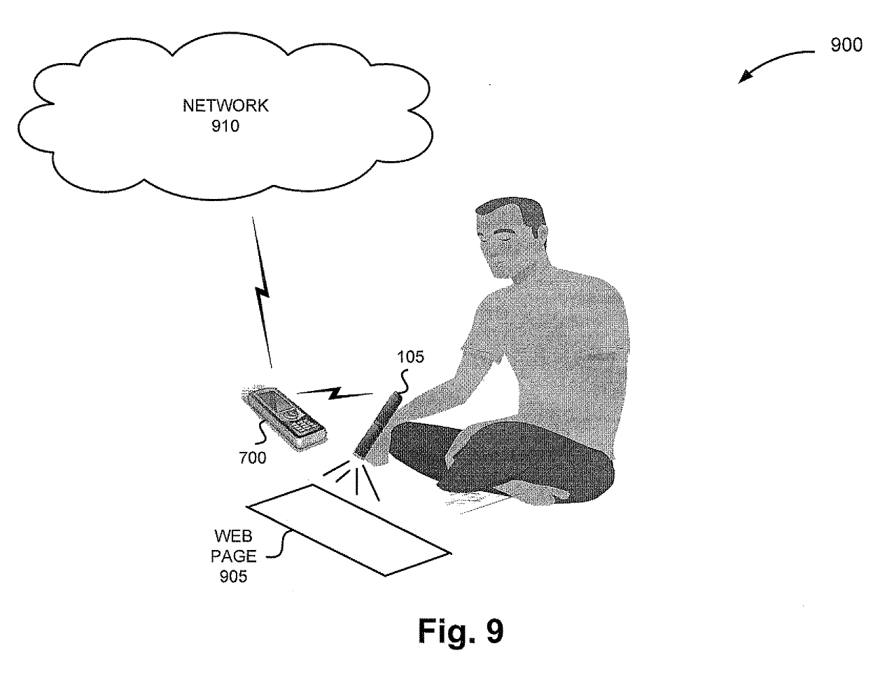

As illustrated in FIG. 9, an exemplary environment 900 may include a user operating device 105 and device 700. Device 105, device 700 and network 910 may be communicatively coupled (e.g., via a wireless link (e.g., Bluetooth, IEEE 802.x, etc.) or wired link). Network 910 may include any type of network. For example, network 910 may include a local area network (LAN), a wide area network (WAN), a cellular network, a mobile network, a public switched telephone network (PSTN), a personal area network (PAN), a private network, a public network, the Internet, an intranet, and/or a combination of networks.

For purposes of discussion, assume that network 910 is the Web. In such an instance, the Web content received via device 700 may be projected by device 105. For example, as illustrated, device 105 may project a web page 905 on a surface. The user may interact with web page 905 by operating device 105 in a manner as previously described.

It will be appreciated that in other instances, the content may correspond to, for example, a user interface of device 700. In such instances, the user may operate and/or interact with device 700 based on the user interface projected by device 105. For example, the user may project a contact list, select a person to call from the contact list, and call the selected person. In this way, the user may use device 105 as an accessory to device 700 to place the call. In other situations, the user may use device 105 to conduct the call. For example, if device 700 is not conveniently located close to the user or device 700 is temporarily misplaced, the user may utilize device 105 to place and/or conduct a call. Although not specifically described, it will be appreciated that user may operate and/or interact with numerous types of applications accessible and/or stored on device 700 while utilizing device 105. It will also be appreciated that device 105 may have the capability to connect to network 910 (directly) without the assistance of device 700. That is, for example, the user may use device 105 to browse the Web and view and/or access (e.g., interact with) web page 905.

### Exemplary Process

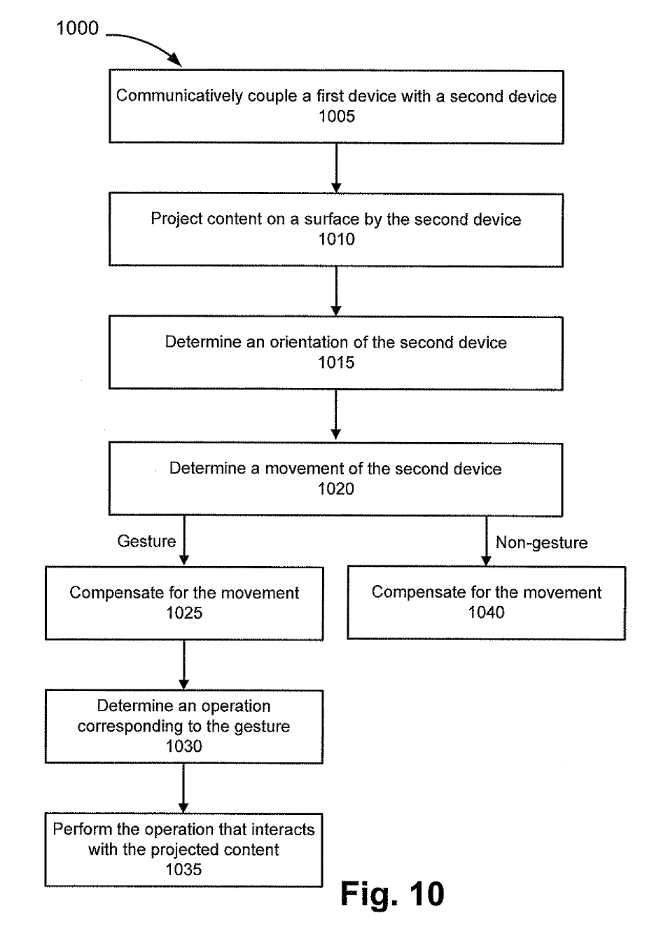

FIG. 10 is a flow chart illustrating an exemplary process 1000 for performing operations that may be associated with the concepts described herein. For example, process 1000 may correspond to operations that may be performed for utilizing device 105 to project content from another device, such as device 700. As previously described, the content may include, for example, a user interface of device 700, network content, content of a third device, etc.

Process 1000 may begin with communicatively coupling a first device with a second device (block 1005). For example, device 105 and device 700 may be communicatively coupled. Device 105 and device 700 may be communicatively coupled via a wired or a wireless link (e.g., Bluetooth, ultra wide band (UWB), IEEE 802, x, etc.).

Content may be projected on a surface by the second device (block 1010). Device 105 may project content on a surface. For example, projector 305 of device 105 may project content on a user's body part (e.g., a user's hand), a wall, a screen, or any other type of surface. The content may include, for example, a user interface of device 700 and/or other forms of content accessible to device 700 (e.g., network content). Device 105 may provide that a user may adjust various parameters (e.g., color, tint, resolution, etc.) associated with the projected content. The projected content may include an indicator 120 to provide a reference to a user and/or device 105 with respect to a subsequent movement or user gesture.

An orientation of the second device may be determined (block 1015). Device 105 may determine an orientation. For example, controller 315 of device 105 may determine the orientation of device 105 based on a reference orientation. For example, the reference may be pre-configured and/or set by a user.

A movement of the device may be determined (block 1020). Device 105 may determine a movement. For example, accelerometer 310 of device 105 may detect a user's gesture with device 105. A gesture may include a trace or path. For example, a user may move device 105 in a relatively straight line from right to left, left to right, up to down, down to up, in a diagonal manner, in a curved manner, freehand, etc. In other instances, a gesture may include a more complex trace or path. For example, a user may make a double tap gesture with device 105. Still, in other instances, a gesture may include a movement with device 105 in combination with, for example, an additional input mechanism of device 105. For example, the additional device 105 input may include pressing a button (e.g., button 205), etc. A gesture may include, in addition to a trace or a path, other aspects of the movement of device 105, such as acceleration, speed, etc., which may be detected. Similarly, accelerometer 310 of device 105 may detect a user's non-gesture with device 105. For example, a non-gesture may include a user's hand shaking or some other undesirable movement. A non-gesture may include movement information (e.g., trace, speed, acceleration, etc.).

Controller 315 may determine whether the movement corresponds to a gesture or a non-gesture. As previously described, a gesture may correspond to a movement of device 105 in which, for example, an operation corresponding to the gesture is to be performed. On the other hand, a non-gesture may correspond to an undesirable movement (e.g. a user's hand shaking, etc.) of device 105. Controller 315 may determine whether the movement corresponds to a gesture or a non-gesture based on the characteristics of the movement. In one implementation, controller 315 may utilize thresholds associated with a movement to distinguish between a gesture and a non-gesture. For example, a trace or path length associated with a non-gesture may be relatively short in comparison to a trace or path length associated with a gesture. That is, given the nature or movement characteristics (e.g., trace, speed, acceleration, etc.) of a non-gesture and a non-gesture, thresholds may be established to allow controller 315 to distinguish between a gesture and a non-gesture.

If it is determined that the movement is a gesture (block 1020-Gesture), then the movement may be compensated (block 1025). For example, device 105 may stabilize the content projected on the surface based on compensation information. For example, controller 315 may determine compensation information based on movement information, distance information, etc. Projector 305 may utilize the compensation information to stabilize the content projected on a surface.

An operation corresponding to the gesture may be determined (block 1030). Device 105 may determine an operation corresponding to the gesture. For example, controller 315 of device 105 may determine an operation (i.e., an operation that interacts with the projected content) based on the gesture. An operation may include, for example, an interaction with the projected content that is analogous to or equivalent to that which may be performed by other conventional devices (e.g., a mouse, a keyboard, a wheel, a joystick, etc.), as well as other operations that may not be possible by such conventional input devices. The operation may also include aspect related to acceleration, speed, etc. For example, an operation such as scrolling may have varying degrees of scrolling (e.g., the speed of the scroll, the length of the scroll, etc.) based on acceleration, speed, etc., associated with the user's gesture.

The operation that interacts with the projected content may be performed (block 1035). For example, device 105 may perform various operations corresponding to the gesture. As previously described, these operations may include selecting, entering data, scrolling, dragging-and dropping, navigating in a menu (e.g., a pull-down menu, a popup menu, etc.), highlighting, etc.

If it is determined that the movement is a non-gesture (block 615-Non-gesture), then the movement may be compensated (block 1040). For example, device 105 may stabilize the content projected on the surface based on compensation information. For example, controller 315 may determine compensation information based on movement information, distance information, etc. Projector 305 may utilize the compensation information to stabilize the content projected on a surface.

Although FIG. 10 illustrates an exemplary process, in other implementations, fewer, additional or different operations than those depicted in FIG. 10 may be performed. For example, depending on the distance between device 105 and a surface in which the content is projected, and the characteristics of the movement, compensation of the movement may not be necessary. It will also be appreciated that components of device 105 described as performing a particular operation, may be performed by other components of device 105, in combination with other components of device 105, and/or components not specifically mentioned herein.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

It should be emphasized that the term “comprises” or “comprising” when used in the specification is taken to specify the presence of stated features, integers, steps, or components but does not preclude the presence or addition of one or more other features, integers, steps, components, or groups thereof.

In addition, while series of blocks have been described with regard to processes illustrated in FIGS. 6 and 10, the order of the blocks may be modified in other implementations. Further, non-dependent blocks may be performed in parallel. Further one or more blocks may be omitted.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the implementations described herein unless explicitly described as such. Also, as used herein, the article “a” and “an” are intended to include one or more items. Where only one item is intended, the term “one” or similar language is used. Further, the phrase “based on” is intended to mean “based, at least in part, on” unless explicitly stated otherwise. As used herein, the term “and/or” includes any and all combinations of one or more of the associated list items.

What is claimed is:

1. A method, comprising:
projecting, by a device, content on a surface;
determining an orientation of the device;
detecting a movement of the device;
determining an operation that corresponds to the movement and interacts with the content; and
performing the operation.

2. The method of claim 1, where the detecting comprises:
determining whether the movement includes at least one of a gesture or a non-gesture, and where the determining the operation comprises:
determining the operation that corresponds to the movement and interacts with the content when it is determined that the movement includes the gesture.

3. The method of claim 1, where the content includes a user interface of the device or other content accessible by the device.

4. The method of claim 1, where the operation includes any one of scrolling, selecting, entering data, highlighting, dragging-and-dropping, or navigating in a menu.

5. The method of claim 1, further comprising:
projecting, by the device, an indicator to navigate within the projected content.

6. The method of claim 1, further comprising:
detecting at least one of acceleration or speed associated with the movement, and the performing the operation comprises performing the operation based on the at least one of detected acceleration or detected speed.

7. The method of claim 1, further comprising:
communicatively coupling the device with another device, and wherein the content includes a user interface of the other device or other content accessible by the other device.

8. The method of claim 1, where the detecting comprises:
detecting a user input in combination with the movement; and
determining the operation that corresponds to the user input in combination with the movement and interacts with the content.

9. The method of claim 1, further comprising:
compensating for an instability of the content projected caused by the movement.

10. A device comprising:
a projector to project content on a surface; and
one or more components configured to:
detect a movement of the device,
determine an operation that corresponds to the movement, where the operation interacts with the projected content, and
perform the operation.

11. The device of claim 10, where the movement is based on a user's gesture with the device.

12. The device of claim 11, where, when detecting the movement of the device, the one or more components are further configured to detect at least one of speed or acceleration associated with the movement.

13. The device of claim 10, where the one or more components are further configured to:
detect an orientation of the device, and the determining the operation that corresponds to the movement is based on the orientation of the device.

14. The device of claim 10, where the device corresponds to a handheld device.

15. The device of claim 10, further comprising:
a transceiver to communicatively couple with another device, and where the content includes a user interface of the other device or content accessible by the other device.

16. The device of claim 10, further comprising:
an input device, and where the one or more components are further configured to:
detect an input received from the input device and when determining the operation, the one more components are further configured to determine the operation based on the movement and the input received.

17. The device of claim 10, further comprising a display.

18. The device of claim 17, where the content includes a software application running on the device.

19. A device comprising:
means for projecting content on a surface;
means for detecting a movement of the device;
means for detecting an orientation of the device;
means for determining an operation that interacts with the content based on the orientation and the detected movement; and
means for performing the operation.

20. The device of claim 19, where the operation includes navigating or moving an indicator within the projected content.

21. The device of claim 19, further comprising:
means for storing the content; and
means for receiving content from another device or network.
